(19) United States
(12) Patent Application Publication
(10) Pub. No.: US 2011/0079630 A1
(43) Pub. Date: Apr. 7, 2011

(54) SYSTEM FOR REDUCING METALLIC WHISKER FORMATION

(75) Inventors: Edward B. Ripley, Knoxville, TN (US); Russell L. Hallman, Knoxville, TN (US)

(73) Assignee: BABCOCK & WILCOX TECHNICAL SERVICES Y-12, LLC, Oak Ridge, TN (US)

(21) Appl. No.: 12/894,999

(22) Filed: Sep. 30, 2010

Related U.S. Application Data
(60) Provisional application No. 61/249,271, filed on Oct. 7, 2009.

(51) Int. Cl. B23K 1/00; B23K 35/22

(52) U.S. Cl. 228/101; 148/23

(57) ABSTRACT

Disclosed is a whisker-formation resistant composition that is suitable for use as a lead-free soldering composition. The composition includes a fusible material and a matrix material that is aggregated with the fusible material. Typically the fusible material has a lower melting temperature than the melting temperature of the matrix material and has a coefficient of thermal expansion that is higher than the coefficient of thermal expansion of the matrix material. Also provided is a method of reducing the formation of whiskers adjacent solder that bridges a joint. The method includes the step of melting a fusible material adjacent the joint. A further step is solidifying the fusible material while establishing a static tensile stress tendency in the fusible material.

### CROSS REFERENCES TO RELATED APPLICATIONS

This patent application claims priority from and is related to U.S. Provisional Patent Application Ser. No. 61/249,271 filed Oct. 7, 2009, entitled: System for Reducing Metallic Whisker Formation. Provisional Patent Application Ser. No. 61/249,271 is incorporated by reference in its entirety herein.

### GOVERNMENT RIGHTS

The U.S. Government has rights to this invention pursuant to contract number DE-AC05-00OR22800 between the U.S. Department of Energy and Babcock & Wilcox Technical Services Y-12, LLC.

### FIELD

This disclosure relates to the field of solder compositions. More particularly, this disclosure relates to lead-free or reduced-lead solder compositions.

### BACKGROUND

Solder is used to join metal parts for such purposes as sealing gaps between pipes and or tubing, forming electrical connections, and joining metal parts. Historically, solder has contained lead. However, lead is a toxic element and consequently efforts have proceeded globally to replace lead-bearing solders with lead-free compositions. Specifically, the Restriction of Hazardous Substances (RoHS) directive was adopted in February 2003 by the European Union and became law in each member state. The RoHS directive took effect in the USA on 1 Jul. 2006. The RoHS directive restricts the use of certain hazardous substances in electrical and electronic equipment. Consequently, while eutectic 60/40 lead/tin solder has been used in the electrical and electronics industry for many years, as a result of RoHS such solder was banned from use in many parts of the world for consumer electrical and electronic systems.

The transition to “lead-free” solder has not been easy because several fundamental problems exist with most lead-free alternatives. Many of the lead-free solder compositions contain tin. Over time, solder joints formed with lead-free solders may grow “whiskers,” which are electrically conductive (and typically crystalline) structures that form adjacent the surface of the solder joint and extend outward. This phenomenon is particularly prevalent in solder joints formed using tin-bearing lead-free solders and in solder joints where tin, especially electroplated tin, is used as a final finish. However, tin is only one of several metals that are known to be capable of growing whiskers. Other examples of metals that may form whiskers include zinc, cadmium, indium and antimony. Tin whiskers have been observed to grow to lengths of several millimeters (mm) and in rare instances to lengths up to 10 mm. Numerous electronic system failures have been attributed to short circuits caused by tin whiskers that bridge closely-spaced circuit elements maintained at different electrical potentials. What are needed therefore are improved compositions of materials and methods that mitigate the tin whisker problem in soldered connections and similar cohered structures.

### SUMMARY

The present disclosure provides a whisker-formation resistant composition that includes a fusible material having a first melting point and having a first coefficient of thermal expansion. The whisker-formation resistant composition also includes a matrix material that is aggregated with the fusible material. The matrix material has a second melting point that is higher than the first melting point and has a second coefficient of thermal expansion that is lower than the first coefficient of thermal expansion.

Also provided in the present disclosure is a method of reducing the formation of whiskers adjacent solder that bridges a joint. The method includes the step of melting a fusible material adjacent the joint. A further step is solidifying the fusible material while establishing a static tensile stress tendency in the fusible material.

### DETAILED DESCRIPTION

The following narrative describes preferred embodiments and the practice of specific embodiments of whisker-formation resistant compositions and methods for reducing the formation of metallic whiskers. It is to be understood that other embodiments may be utilized, and that structural changes may be made and processes may vary in other embodiments.

Conventional lead-free solders are fusible materials. The terms “fusible material” and “fusible composition” as used herein refer to a material or a composition of material that is capable of being fused (melted) at a temperature that is lower than about 500° C. Fusible materials and fusible compositions may include lead or may be lead-free. Various formulations of lead-free fusible compositions are available for use as solders, and most such solders are a eutectic alloys. Typically lead-free solders are tin-based with small amounts of other metals such as bismuth, silver and antimony being alloyed together with the tin to form the lead-free solder. In some compositions other metals such as indium, cadmium, selenium and zinc may be alloyed with the tin and the other metals to form the lead-free solder. Fusible material compositions are typically formulated by heating the constituents to a temperature where they all melt and then alloy together forming a eutectic that subsequently melts at a temperature that is lower than the melting temperature of copper. One example of a commercial lead-free solder is “SAC305” which contains approximately 95.5% tin, 4% silver, and 0.5% copper.

The terms “tin whisker,” “whisker,” and “metallic whisker” are used interchangeably herein to refer to any whisker-like structure formed adjacent a fused material. The terms “fused material” and “fused composition” as used herein refer to a material or a composition of materials that has/have been melted and then solidified to form a cohered object, such as a solder joint. As used herein the term “solder joint” refers to a junction of two or more objects where solder bridges a joint between the objects.

Without being bound by any scientific theory, it is believed that lead-free solder joints may be prone to form whiskers in situations where a solder joint has solidified with larger than average grain sizes. Whiskers may also be prone to form in solder joints where there is an internal path for tin to diffuse to a surface feature that becomes a growth site for a tin whisker. Lead-free solder joints may also be prone to form whiskers when the solidified solder is under internal compressive stress. Such compressive stress may be introduced simply by the process of solidifying the solder at the solder joint. A tendency to form internal compressive stress may be mitigated by creating an environment that induces offsetting internal tensile stress (i.e., static tension). Specifically, it may be desirable to melt a fusible lead-free composition adjacent the joint to initiate a solder joint, and then to solidify the fusible lead-free composition while inducing tensile stresses in the fusible lead-free composition. It is to be understood that additional steps may precede the recited initiating step, such as cleaning, applying a flux, and so forth.

One way to establish internal tensile stress in a solder joint is to melt a fusible material in the presence of a matrix material (preferably a metal matrix), such that the molten fusible material adheres to the metal matrix material. Here the term “adheres to” refers to a condition where the molten fusible material wets the surface of the matrix material. Persons of ordinary skill in the art will recognized that this wetting action refers to a bonding between the molten fusible material and the matrix material that typically occurs at the molecular level. Then, once the fusible material has adhered to the matrix material, the solder joint is cooled. Cooling the solder joint shrinks the fusible material at a first rate of shrinkage as the fusible material solidifies. Concurrently as the solder joint is cooled, the matrix material also shrinks. Typically the matrix material shrinks at a second rate of shrinkage and the second rate of shrinkage is different (and preferably less) than the first rate of shrinkage (of the fusible material). If the second rate of shrinkage is less than the first rate of shrinkage, then after the molten fusible material coats and adheres to the matrix material and the molten fusible material is cooled, the matrix material stretches the fusible material such that the fusible material solidifies interstitially with the matrix material in a state of less internal compressive stress than if the matrix material were not present. This modification of internal stress is referred to herein as establishing a “static tensile stress tendency” in a fusible material after it solidifies to form a solder joint or other cohered object. This static tensile stress tendency may retard or eliminate the formation of whiskers adjacent the surface of the solder joint or other cohered object.

The term “whisker-formation resistant composition” is used herein to describe materials that typically include a fusible material and a matrix material. A whisker-formation resistant composition may be used in such applications as solder joints (previously defined), tinned elements, and fusible (eutectic) links. Tinned elements are articles that have a thin coat of solder applied to a surface. Tinned elements are often fabricated as precursor materials for use in a subsequent process to fabricate a solder joint. Tinned elements may also be used in final assemblies without the formation of a solder joint for such purposes as providing improved electrical conductivity for instrument test points, preventing fraying of multi-strand conductors, and providing corrosion resistance. Fusible (eutectic) links are elements that are specifically designed to melt at a specified temperature. Fusible links are used, for example, in fire protection safety systems and to form electrical protection devices like electrical fuses. In some embodiments the combination of the matrix material and the fusible material may be used as a semisolid or thixotropic metal for semisolid processing applications. In some embodiments the combination of the matrix material and the fusible material may be used for casting components. Solder joints are used hereinafter as examples of applications of whisker-resistant compositions, but it is to be understood that such compositions may also be used in other applications such as those described in this paragraph.

As previously suggested, one way to establish different rates of shrinkage in a solder joint is to use a matrix material having a lower coefficient of thermal expansion (CTE) than the CTE of the fusible material. In such embodiments, to initiate a solder joint, a soldering composition that includes a mixture of the fusible material and the matrix material is heated until the fusible material melts to form a molten solder joint. The matrix material is heated with the fusible material such that the fusible material adheres to the matrix material. The soldering composition is not heated to a temperature where the matrix material melts or significantly diffuses into (or alloys with) the fusible material. After the molten solder joint is formed it is cooled, and as the soldering composition starts to cool, the matrix material and the fusible material start to shrink. If the fusible material and the matrix material were both in a free (unrestrained) state, for every temperature degree of cooling the higher CTE fusible material would shrink more per unit volume than the lower CTE matrix material. However, in the presently-described circumstance, as the fusible material and the matrix material start to cool the fusible material that is immediately adjacent the matrix material will tend to solidify first. Thereafter the fusible material and the matrix material are not in a free (unrestrained) state—rather they are bound to each other. As further cooling occurs the fusible material attempts to shrink more per unit volume than the matrix material for each temperature degree of cooling, but since the materials are bound together, static tensile stress is induced in the fusible material. This tensile stress may cause some shrinkage voids to occur in the fusible material, which is undesirable because it relieves some of the induced static tensile stress. However, even with such voids a static tensile stress tendency may be established in the solidified (fused) fusible material.

Again, without being bound by any scientific theory, the formation of whiskers may be mitigated or eliminated because (a) the compressive forces in the fusible composition are significantly reduced, and/or (b) the matrix material physically blocks the growth of whiskers, and/or (c) the matrix material prevents migration of whisker-forming metals to the surface of the solder joint by blocking diffusion paths, and/or (d) the matrix materials form crystal nucleation points that promote smaller grain sizes.

The matrix material with which the fusible material is fused typically comprises intermingled particles. The use of micro-, nano- or pico-sized particles may be beneficial. One potential benefit of using small particles is that some desirable solder composition properties (such as molten flow rate) improve with a decrease in the particle size. Another benefit of using small particles is that the amount of static tensile stress tendency also increases as particle size decreases. A preferred embodiment may include nanoparticles and may include a wide range of particle size distributions. In such embodiments smaller particles beneficially fill interstitial spaces between larger particles. Some embodiments may include matrix materials other than particles, such as wires, meshes, or foams, sponges, wicks or mesh materials. A complete soldering composition comprising a lead-free composition and a matrix material may be provided as a wire, as a paste, or as a preform. The soldering composition may be used in manual soldering systems or used in automated soldering operations, such as wave soldering machines.

As an example embodiment, a solder may be formulated using iron or steel as the matrix material along with a lead-free fusible material that has a formulation that will not appreciably dissolve or alloy with the iron or steel matrix. Some lead-free solders use copper that is alloyed with other metals to form the fusible material. However, that is different than the use described herein of copper as a matrix material with an associated fusible material to form a whisker-formation resistant solder (or a whisker-formation resistant composition for use in non-soldering applications). For most embodiments described herein, after matrix and fusible materials are mixed together to form a whisker-formation resistant composition, the matrix materials do not appreciably dissolve or alloy with the associated fusible material because, in use, the whisker-formation resistant composition is generally not heated to the melting temperature of the matrix material such that it could form an alloy with the fusible material. The expression “aggregated with” is used herein to refer to compositions comprising matrix materials that are mixed with an associated fusible material and that do not appreciably dissolve into or alloy with the associated fusible material at their intended application temperature.

Typically, in a whisker-formation resistant soldering composition, the melting point of the fusible material is lower than about 450° C. and generally it is in a range from about 90° C. to about 450° C. The melting point of the matrix material is generally greater than about 450° C. For example, iron, which may be used as a matrix material, has a melting point is about 1538° C. Materials with even higher melting points may be used as matrix materials, with the general provision that the melting point of the matrix material is higher than the melting point of the fusible material.

The formulation of a lead-free solder is generally further selected such that fusible lead-free composition will liberally wet the surfaces of the matrix material. Most lead-free fusible materials will wet iron, steel, or copper particles. Also typically, the fusible lead-free composition is further selected such that it has a higher coefficient of thermal expansion than the matrix material. It is preferable that the majority of the volume of a lead-free soldering composition comprises the lower CTE material. So, in an exemplary composition, iron (which in pure form has a CET of about 12.0 (10⁻⁶ m/m K) makes up approximately 60 volume percent of the soldering composition, and the other (nominally) 40% portion of the soldering composition is a lead-free fusible material comprising one or more of elements selected from the group consisting of tin, bismuth, silver, antimony, indium, cadmium, selenium and zinc. Tin has a CTE of about 23.4 (10⁻⁶ m/m K).

A solder joint may be formed by melting the just-described exemplary lead-free fusible composition in the presence of the iron matrix material. The solder joint is then cooled to a temperature below the melting point of the lead-free fusible composition. The resultant solidified lead-free fusible composition will at least be under less compressive stress than if the iron matrix material were not present. In some embodiments of such a soldering composition and method, the solidified lead-free fusible composition may be under substantially no stress or may be under static tensile stress.

In order for the fusible material to wet with some certain matrix materials like cast iron, steel, ceramics, titanium, magnesium or similar matrix materials, it may be necessary to plate the matrix materials with a suitable metallic material to promote interfacial bonding with the fusible material.

Copper may be used as a matrix material, but copper has a somewhat greater tendency than iron or steel to alloy with fusible materials. However, in some cases, some dissolution of the matrix material into the fusible material may be acceptable. In other cases (where dissolution is a problem) the copper particle matrix material may be plated with a suitable metallic element that induces interfacial bonding but that does not dissolve appreciably in the fusible material.

As previously indicated, preferred embodiments for reducing tin whisker formation reduce the amount of compressive stress in a solder joint, and may establish a state of tensile stress in the solidified solder joint. In an example embodiment, the matrix material may occupy up to 60 volume % of a whisker-formation resistant composition with the remaining volume % being the fusible material (e.g., a lead free solder). In a composition like this, almost 100% of the solder would be expected to have distortions in the crystalline structure caused by the solidification around a matrix material particle with lower CTE. Such distortion is desired because it is expected to reduce the tendency to form whiskers. In cases where the volume % of the matrix material particle approaches the 60 volume % upper limit, the strength of the tensile strain field starts to drop off along an imaginary path moving away from one particle, but then the strength of the tensile strain field increases as the imaginary path approaches a neighboring particle. In such configurations practically all of the solidified solder may be in a state of tensile stress because of the overlapping strain fields.

In practice the inclusion of 40-50 volume % of the matrix material may represent a more practical limit due to difficulties in flowing the molten composition with such a high volume percent of matrix material. When the matrix material is less than 40 volume %, the material directly adjacent the matrix material particle is likely to be under tensile stress, but further away from the matrix particle the tensile stress is reduced. Such reduction in tensile stress reduces the ability of the composition to mitigate the formation of whiskers.

A typical whisker-formation resistant composition may be 20-60 volume % of the matrix material in 80-40 volume % of the fusible material. As an example 50-60 volume % of iron powder (preferably that has been coated with a flux or plated with a material like electroless tin to enhance wetting) may be mixed with a suitable fusible material such as SAC305 lead free solder. Typically the fusible material is provided as bar, cored wire, solid wire, foil, a preform, powder, or paste. The fusible material is melted and mixed with the matrix material (if the matrix material is a powder or a wire) or melted and infused into the matrix material (if the matrix material is a continuous structure other than a wire). The resultant whisker-formation resistant composition is then typically cooled to solidify for storage until needed for a manufacturing operation.

In cases where the difference between the CTE of the fusible material and the CTE of the matrix material particle is large, the amount of the matrix material required is reduced. When the difference between the CTE of the fusible material and the CTE of the matrix material particle is small, more of the matrix material is typically required to have the same net effect.

In cases where the matrix material has relatively high thermal conductivity (as in the case of aluminum or copper), the time required for the heat to be transferred through the solder to reach the melting temperature is significantly reduced. This can be a benefit for temperature sensitive components because it limits the time at temperature and thus limits thermal damage.

It is important to note that while most of the discussion of embodiments herein refers to fusible “lead-free” compositions, some embodiments may employ fusible compositions that contain some lead. For example, compositions and methods disclosed herein may be used to dilute conventional lead-based solder systems where, for example, a 60% iron and 40% lead based eutectic solder might be reduced from 40% lead by volume to 16% lead by volume. This would reduce the toxicity of a conventional solder system considerably. Such techniques may be used to modify an existing soldering system for forming new solder joints (obviating the need to discard a large existing batch of lead solder) or the techniques may be used in a system for refurbishing existing lead-based solder joints. Such applications would likely increase the electrical conductivity of a traditional lead solder joint and would also likely reduce the total systemic power consumption because of reduced electrical resistance in the solder joints.

The principal benefit of most embodiments of the soldering compositions and methods disclosed herein is that it mitigates or eliminates the problem of whisker formation. A secondary benefit of most embodiments is that compositions may be formulated to comply with most Restriction of Hazardous Substances (RoHS) regulations that are directed toward elimination or minimization of lead in soldering compositions. Some further benefits of some embodiments of soldering compositions and methods disclosed herein are as follows. The matrix material may be selected to have a high electrical conductivity, which lowers electrical resistance through a solder joint. The soldering composition may be tailored to melt at a temperature selected over a wider range of temperatures by selecting an appropriate eutectic composition. Methods may be used to modify existing lead-free soldering systems that are known to produce whiskers and thereby reduce or eliminate whisker formation. Soldering compositions and methods disclosed herein may be used in non-electrical applications where fractured tin whiskers cause mechanical failure.

In various embodiments the matrix material may be a metal, ceramic, or other material that wets with the solder system, provided in general that the matrix material has a lower CTE than the fusible material and that the matrix material does not appreciably alloy with or dissolve in the fusible material. In some embodiments, surfaces of the matrix material may be coated with a thin film of the associated fusible material, and/or with a flux.

In summary, embodiments disclosed herein provide various embodiments of whisker-formation resistant compositions and various embodiments of methods for reducing the formation of whiskers adjacent solder that bridges a joint. The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

What is claimed is:

1. A whisker-formation resistant composition comprising:
a fusible material having a first melting point and having a first coefficient of thermal expansion; and
a matrix material aggregated with the fusible material, the matrix material having a second melting point that is higher than the first melting point and having a second coefficient of thermal expansion that is lower than the first coefficient of thermal expansion.

2. The whisker-formation resistant composition of claim 1 wherein the fusible material is lead-free.

3. The whisker-formation resistant composition of claim 1 wherein the fusible material comprises less than about fifty percent of the whisker-formation resistant composition and the matrix material comprises more than about fifty percent of the whisker-formation resistant composition.

4. The whisker-formation resistant composition of claim 1 wherein the first melting point that is lower than about 450° C. and the second melting point is greater than about 450° C.

5. The whisker-formation resistant composition of claim 1 wherein the first melting point is in a range from about 90° C. to about 450° C. and the second melting point is greater than about 450° C.

6. The whisker-formation resistant composition of claim 1 wherein the matrix material comprises particles selected from the group consisting of micro-sized particles, nano-sized particles, and pico-sized particles.

7. The whisker-formation resistant composition of claim 1 wherein the matrix material comprises iron.

8. The whisker-formation resistant composition of claim 1 wherein the fusible material comprises one or more of elements selected from the group consisting of tin, bismuth, silver, antimony, indium, cadmium, selenium and zinc.

9. A method of reducing the formation of whiskers adjacent solder that bridges a joint, comprising:
(a) melting a fusible material adjacent the joint; and
(b) solidifying the fusible material while establishing a static tensile stress tendency in the fusible material.

10. The method of claim 9 wherein:
step (a) comprises melting the fusible material adjacent the joint in the presence of a matrix material, wherein the fusible material adheres to the matrix material; and
step (b) comprises solidifying the fusible material while (i) shrinking the fusible material at a first rate of shrinkage, and (ii) shrinking the metal matrix at a second rate of shrinkage, where the second rate of shrinkage is less than the first rate of shrinkage.
